(19) United States
(12) Patent Application Publication
(10) Pub. No.: US 2004/0093991 A1
(43) Pub. Date: May 20, 2004

(54) Shallow well sockets with, or mounting to, short drive posts connecting to thin sprocket/socket wrenches; including wrenches with mechanically-linked co-rotating turning heads

(76) Inventor: Mel Wojtynek, Carlsbad, CA (US)

Correspondence Address: FUESS & DAVIDENAS, Suite II-G, 10951 Sorrento Valley Road, San Diego, CA, 92121-1613, US

(21) Appl. No.: 10/406,704

(22) Filed: Apr. 2, 2003

Related U.S. Application Data
(63) Continuation-in-part of application No. 10/300,054, filed on Nov. 19, 2002.

(51) Int. Cl. B25B 17/00

(52) U.S. Cl. 81/57.3

(57) ABSTRACT

A shallow-well socket suitably driven by the drive post of a rotary tool to apply torquing force to, and to turn, a fastener having a head of thickness H. In one embodiment the shallow-well socket has a generally tubular body of length C less than or equal to two and one-half times the thickness H of a head of a fastener that is turned by the body, C≦2.5H. A distal-end region of length D internally suitable to fit the head of the fastener, ½H≦D≦H, connects to a central region of length E serving as a back wall to a distal-end cavity 0≦E≦½H, connects to a proximal-end region of length F internally suitable to fit over the drive post of a rotary tool, ½H≦F≦H. D+E+F=C. The socket is particularly beneficial of use with a thin double-ended ratchet (sprocket), or a socket, wrench with (1) an elongate body having (2) a rotatable turning head at each end of the elongate body, and (3) a mechanism within the body for mechanically linking rotation of each turning head to the other.

### RELATION TO RELATED PATENT APPLICATIONS

The present patent application is related to U.S. patent application Ser. No. ______ filed on an even date herewith for RATIO-DRIVE SPROCKET/SOCKET WRENCHES WITH TWO OR MORE MECHANICALLY-LINKED CO-ROTATING TURNING HEADS. The present application is also related as a continuation-in-part to U.S. patent application Ser. No. 10/300,054 filed on Nov. 19, 2002, for a SPROCKET/SOCKET WRENCH WITH MECHANICALLY-LINKED CO-ROTATING TURNING HEADS. All applications are to the same inventor Mel Wojtynek. The contents of the related patent applications are incorporated herein by reference.

### BACKGROUND OF THE INVENTION

1. Field of the Invention

The present invention concerns sockets of both normal, or thin wall, and impact, or thick wall, types for use with any of socket wrenches, breaker bars, ratchet and sprocket wrenches and the like mounting drive adapters, where the sockets are shallow well, or short, in each of opening depth, bolt clearance depth, and overall length.

The present invention particularly concerns (i) shallow well sockets (ii) integrating, or adapted for use with, short drive posts, that connect to, preferably, (iii) sprocket wrenches, ratchet box end wrenches, or socket wrenches that are themselves thin, and that more preferably connect to a thin variant of a new type sprocket/socket wrench with mechanically-linked co-rotating turning heads in accordance with the related predecessor application.

2. Description of the Prior Art

2.1 Because Socket Driver Tools Have Appreciable Extent in the Axis of a Socket, Shallow Well Sockets, Which Have Limitations, Have not Previously Been Attempted

Before commencing explanation, it should be noted that, circa 2002, use of the word “shallow” as regards sockets of the types that are driven with a socket wrench is somewhat inconsistent. Many references to “shallow sockets” are locatable on, by way of example, the Internet. The use of the term invariably refers to sockets of modern normal size as opposed to deep well sockets: i.e.; “shallow” versus “deep”. These ordinary sockets, if not simply referred to as “conventional”, or “normal”, or “standard”, or the like, would be more exactingly identified as “shallow well sockets”. Thus “shallow well” could then be contrasted with “deep is well” in description of sockets just as “thin wall”—which is essentially any modern standard socket of quality—is contrasted with “thick wall”, or impact, sockets.

The present invention will be seen to concern sockets that have particularly shallow wells, and this term will be defined as applied to the sockets. These sockets of the present invention will also be seen to be quite narrow in their structural region located behind the wells where connection is made to a (typically square) driver post of a socket drive tool. The “shallow well” sockets of the present invention will thus be seen to be not only shallow in their wells, but very thin and flat, or “squat”, overall. They are thus the diametric opposite of a “deep well”, or “tall”, socket.

In the amazingly versatile world of tools such sockets have not, to the best knowledge of the inventor, heretofore been made because of at least two reasons. First, if it is considered, for example, that the socket is being used on a nut through the center of which nut runs the cylindrical body of a bolt, then when and if this bolt body extends thought the nut engaged by the socket, the socket must be deep enough to encompass within its well the bolt extension. Otherwise, the socket and socket driver tool risk being held off from the nut, potentially slipping in application of torque force to the nut, and undesirably deforming its hexagonal faces.

However, it can be contemplated that adequate purchase may be gained upon some nuts, or the heads of all square and hexagon bolts, by some sockets as are so shallow that their wells are, as is preferred in the present invention, only as deep as the nuts, or bolt heads, are high. Since clearance problems with nuts and bolts often exist, why do not these “very” shallow well sockets appear to exist—howsoever rare they might be. The answer is probably that the rotary driver tools—socket wrenches, breaker bars, ratchet and sprocket wrenches and the like mounting drive adapters—that are used to turn the sockets have themselves considerable thickness. Therefore it is nonsensical to try and save, maybe, some tenths of an inch in the depth of the well of a socket when the tool that is used to turn the socket is already, most typically, more than an inch thick (in the axis of the socket).

If, however, socket driver tools could be made much thinner in the direction of the axis of the socket, and on the order of the height of a nut, or of the head of a bolt, then, for reasons of clearance in tight quarters, it might be useful to explore very “shallow well” sockets, and the means of coupling, driving and using the same.

The related, predecessor, invention of a sprocket/socket wrench with mechanically-linked co-rotating turning heads concerns such a socket (and other bit) driver tool that can be made unusually thin in the axis of the socket. The remainder of this section concerns the background to that tool as is also found in the related predecessor application, and is repeated in this specification for the sake of completeness.

2.2 A Basic Ratchet Wrench

The related predecessor invention generally concerns a hand tool for imparting rotational and torquing forces; particularly a hand tool for delivering into a workpiece, especially in a confined space, rotational and torquing forces about a drive axis that is spaced-parallel to, but separated at some distance from, a driven axis where rotational motion and torque forces developed externally to the tool are received into the tool.

The related predecessor invention particularly concerns a hand tool for offsetting (1) externally-developed rotary motion, and torque forces, received into (1a) a proximal-end turning head of the tool, into (2) corresponding rotary motion, and torque forces, at (2a) a distal-end turning head of the tool, and about (2b) another, drive, axis that is parallel to the driven axis, but displaced from it. The transmission of forces between the (1a) driven, proximal-end, turning head and the (2a) driving, distal-end, turning head is preferably by a gear train, and more preferably by meshing gears that are in line a body of the tool, each of which gears rotates about axis that is spaced-parallel to both the driving, and to the driven, axis.

U.S. Pat. No. 2,500,835 to J. W. Lang for a RATCHET WRENCH shows the basic form of the tool that is improved by the related predecessor invention.

2.3 Rachet Wrenches Where Something is Moved Along the Axis of the Handle to Rotate a Sprocket or Spindle

There is a class of rachet wrenches where something is moved along the axis of the handle of the wrench in order to rotate a sprocket or spindle.

U.S. Pat. No. 2,288,217 to Trautman for a DOUBLE RATCHET WRENCH shows a ratchet wrench where turning of a sprocket gear may be realized by longitudinal telescoping movement of a handle connected to the sprocket gear by a link chain, as well as by a normal pivoting movement of the tool handle.

U.S. Pat. No. 2,530,553 to Strobel for a CHAIN DRIVEN RATCHET WRENCH shows a ratchet wrench where turning of a sprocket is realized by rotation of an internal loop chain in response to a reciprocating movement of a shuttle that is built into the handle of the wrench.

U.S. Pat. No. 3,447,404 to Christian for a HIGH SPEED RATCHET WRENCH concerns a ratchet wrench where a spindle affixed to an internal drum is turned by action of pulling longitudinally in the direction of the handle a cord that is wrapped about the drum. Operation is in the manner of spinning a toy top.

U.S. Pat. No. 4,224,844 to Henriksen for a RATCHET BOLT DRIVE APPARATUS INCORPORATING BIDIRECTIONALLY OPERABLE RECIPROCATING DRIVE MEANS concerns a ratchet drive mechanism for rotating a bolt in response to both (1) torque that is applied to a handle, and (2) a bidirectionally-operable reciprocating means. The handle supports a drive chain which rotates around a pair of sprockets. A push rod supports a lock means which engages the chain. The lock means hooks against the chain, permitting the chain to be pushed and pulled on alternate strokes. The chain is thus rotated around the sprockets, one of the sprockets being an idler and one of the sprockets being mounted on the exterior of the drive of the mechanism. When low torque is required, the push rod can be reciprocated. When high torque is required, the handle can be pivoted.

U.S. Pat. No. 4,507,989 to Baker for a RATCHET TOOL concerns a ratchet tool comprises a tubular body with a handle at one end and a ratchet drive at the other end. The handle mounts a lever mechanism which is operatively connected to the ratchet drive by a plunger, a gear mechanism and a flexible member. When the lever mechanism is operated linear movement of the plunger translates through the gear mechanism and the flexible member into rotary motion of the ratchet drive. With the lever mechanism removed the ratchet tool can be used as a conventional ratchet.

2.4 Rachet Wrenches Having Plier-like Handles that are Squeezed to Rotate a Sprocket or Spindle

There is another class of rachet wrenches having pliers-like handles that are squeezed or otherwise moved in order to rotate a sprocket or spindle.

U.S. Pat. No. 3,286,560 to Murray for a RATCHET WRENCH shows a pliers-type wrench where turning of a spindle is realized by squeezing of a pliers-type handle about a pivot so as to rotate a turning head having the form of an apertured cylinder or a square spindle.

U.S. Pat. No. 3,447,404 to LaChance for a SOCKET WRENCH WITH LEVER OPERATED PAWL MEANS AND A THRUST BLOCK FOR SAID PAWL MEANS shows a wrench with a single handle pivoting against a thrust block so as to, by action of a linkage including a pawl, rotate a distal-end socket. The pivot axis of the handle is thus removed in a proximal direction from the distal-end socket, and from the workpiece.

U.S. Pat. No. 3,941,017 to Lenker, et al. for a PLIER TYPE RATCHET WRENCH concerns a plier-type ratchet wrench of simple, economical and robust construction employing (1) a single rigid thrust rod or bar to operate the ratchet drive, and (2) a single extensible helical spring which both biases the operating handle to its normal position and keeps the thrust rod and a pawl engaged with the ratchet.

2.5 A Combination Reciprocating and Squeezing Handle to a Ratchet Wrench

U.S. Pat. No. 4,656,894 to Goetz for a RATCHET WRENCH concerns a ratchet wrench having a chain drive and three separate operating handles that permit the wrench to be operated in three different modes providing various degrees of torque and various speed ratios.

2.6 A Double-Ended “Offset Socket” Wrench

Perhaps the closest prior art the present and related inventions is the “offset socket” tool of Snap-On Technologies, Inc. [“Snap-On”] that was shown in catalog number 500 of Snap-On and sold for a period during years 2000-2001. The tool has a square drive “input end” sprocket, and a six or a twelve point “output end” sprocket, that are rotationally coupled, one to the other, by a special circular “chain” engaging the exterior of each end's sprocket. The tool uses an unlinked pin “chain” where pins drive the sprocket teeth. In the center of each pin is a groove similar to that used for an external snap ring. The pins are separated by plates that ride in pin grooves. The pins ride in a groove around the tool. When force is applied at the drive sprocket, pins and plats are pushed, applying force to the slave sprocket.

### SUMMARY OF THE INVENTION

The present invention contemplates socket, and socket drive systems, that are extremely squat and short, meaning that the entire height of the combined socket and socket drive tool above the head of a rotary fastener driven by the socket and the drive tool—most often a hexagon bolt or nut—is very small, and is typically on the order of only about three times the thickness of the head of the driven fastener. For example, and without being in the way of limitation, the head of a standard ANSI B18.2.1-1965 hexagon bolt (nut) of ⅜″ size is nominally 0.243″ (0.337″), and the preferred socket, and socket drive system of the present invention will slide over such a bolt head (or nut) within a clearance of less than about 1″, and will then proceed to drive the bolt (or nut) in rotation at an extension of above the bolt head (or nut) of less than about ¾″.

Further—and although many quality socket, ratchet box end, and sprocket wrenches are touted to have a finely stepped rachet mechanism, and to sometimes be capable of performing useful racheting action at angular displacements as small as 5°—the short and shallow socket system of the present invention is preferably (but not necessarily) combined with a new type sprocket/socket wrench having mechanically-linked co-rotating turning heads. This new sprocket/socket wrench requires no—zero—degrees of pivot movement in order to provide torque force, and rotary motion, to a driven socket and fastener.

Still other criteria relevant to applying rotary drive force to fasteners in close quarters include each of (i) the thickness of the wall (not the well, but the wall) of the socket, (ii) the width of the socket driver tool (providing that the thickness of this tool is of the order of the thickness of the head of a hexagon bolt or nut, as stated above), and (iii) the overall length of the socket driver tool.

As regards the thickness of the socket's wall, the shallow-well sockets of the present invention can be made at all wall thicknesses, including the thick walls of an impact type socket. However, because the depth over which torque forces must be communicated is very shallow, the shallow-well sockets of the present invention can be, and preferably are, made with very thin walls. These very thin walls are in thickness potentially no more than the ½ difference between the diameter of the bolt and the maximum width across the corners of the bolt head. For example, and again without being in the way of limitation, with the diameter of a 3/81″ bolt being 0.375″, and the maximum width across opposed corners of this same hexagon head being 0.577″, a shallow-well socket in accordance with the present invention quality made of appropriately strong metal may have a wall as thin as ½ (0.577.3750)=0.1 inches and still transmit conventional torque loads (which are on the order of hundreds of ft.-lbs. for a ⅜″ bolt).

As regards the width of the socket driver tool, the preferred new sprocket/socket wrench with mechanically-linked co-rotating turning heads of the related predecessor invention need not be of any greater diameter than the (permissively very thin wall) shallow-well socket that it serves to drive (without ratcheting motion!). For example, and still without being in the way of limitation, the maximum width across opposed corners of a hexagon head bolt is 0.577″ while each wall of an enveloping thin-wall socket may be as thin as 0.1″—as were both stated above. The new sprocket/socket wrench that serves to drive this socket may thus itself also be only about ¾″ in width.

Finally, the preferred new sprocket/socket wrench may be of any desired length.

Any one of these many extreme properties of the socket and socket driver system of the present invention may be individually useful in applying torquing force to, and in turning, a rotary fastener such as a hexagon bolt (or nut) that is located in a position to which access is limited by any of (i) clearance height above the bolt (or nut), (ii) clearance around the periphery of the bolt (or nut), or (iii) permissible ratchet angle of a socket driver tool rotating a socket engaging the bolt (or nut). However, in combination, these many extreme properties of the socket and socket driver system of the present invention permit the rotation of fasteners located in positions in which the application of torquing forces, and rotational motion, was heretofore deemed impossible.

The simplest example is, perhaps, a bolt extending through the inside sidewall of a pipe (perhaps as may be used to fasten something to the outside of the pipe) where the pipe is of a diameter that is only slightly greater than is the length of the bolt. Consider when the head of the bolt is located sufficiently deep within the pipe from a butt end opening of the pipe that any meaningful angular rotation of anything that might be slipped over this bolt head (such as a long slim box end wrench) becomes effectively impossible. However, in accordance with the present invention it will be found possible to turn and, indeed, to strongly torque, this “inaccessible” bolt in a manner that will be more fully appreciated after study of the drawings and accompanying specification.

1. A Shallow-Well Socket

Accordingly, in one of its aspects the present invention is embodied in a shallow-well socket suitably driven by a rotary tool through a drive post connecting tool and socket in order to apply torquing force to, and to turn, a fastener having a head of thickness H. The (male) drive may be (i) integral to the (female) socket, comprising a rearward extension thereof, (ii) a separate piece, or post, between one complimentary cavity, normally square, at the base of the (shallow-well) socket and another within a sprocket drive of the rotary tool, or (iii) integral with the rotary tool, which is then called a socket wrench. A practitioner of the mechanical arts will recognize that it is not important how the drive of a (shallow-well) socket by a rotary drive tool is partitioned into pieces, nor which pieces may be formed integrally with one another, but rather how this drive is organized, sized and adapted so that, in particular, it will extend but slightly above the head of a fastener that is engaged by the shallow-well socket. Exactly how shallow will be this socket, and this extension, establishes the “metes and bounds” of the present invention.

The shallow-well sockets normally come in sets such as may, ultimately, be driven by rotary drive sprocket (i.e., female) and socket (i.e., male) tools having, most commonly for the English and American Systems, drive apertures (for the female, apertured sprocket wrenches) or drive posts (for the male socket wrenches) of ¼″, ⅜″, ½″, etc. All shallow well sockets of a set are most normally sized to the largest socket of the set, or, more exactingly, to the standard bolt head that the largest socket of the set serves to drive. Therefore the following expression of dimensional relationships between, on the one hand, a shallow well socket and, on the other hand, a workpiece bolt, will be understood to strictly apply only to the largest socket of each set. Certain parts of the shallow-well sockets of a set that remain of uniform size—such as the drive shaft or drive aperture—and other parts that are in proportion to the size of the socket—such as the depth and diameter of the well—will be clear to a toolmaker, and multiple sockets of a sense are proportional in a conventional manner. By consideration of the extreme dimensions, following, it will be quickly understood that the present invention is embodied in shallow-well sockets and, indeed, in a complete integrated socket drive system characterized in that the total height of the total drive system above the workpiece bolt is very, very short.

The shallow-well socket of the present invention includes a generally tubular body of total length C that is less than or equal to two and one-half times the thickness H of a head of a fastener that is turned by the body, C≦2.5H. This socket extends between (1) a first-end opening in tubular body at length distance 0 (zero) which first-end opening fits over the head of the fastener, and (2a) the tip of a drive post, or else (2b) a second-end opening—both at length distance C—to which and by which connects a rotary tool. A (shallow-well) socket with an integral drive post is called a “driver socket”, and is most preferred in the present invention. It is, however, possible to make the (shallow-well) socket with a normal rear, and typically square, aperture that will be engaged by a drive post that is either connected to a hole in sprocket wrench, or integral to a socket wrench. Such a (shallow-well) socket without an integral drive post is called a “double opening shallow-well socket”, and is less preferred in the present invention.

Notably, no matter how the shallow-well socket is formed in its regions connecting to the driver tool, the combination thickness of the socket and the driver tool remains the same, mutatis mutandis.

Either type shallow-well socket has (i) a distal-end region of length D internally suitable to fit the head of the fastener, the length D being greater than or equal to half the thickness H of the head of the fastener but less than or equal to the thickness H of the head of the fastener, ½H≦D≦H. Either type shallow-well socket further has a (ii) a central region of length E suitable to serve as the back wall to the (i) distal-end region. This (ii) central region may optionally be centrally relieved at a side and in a portion facing the (i) distal end region so as to best accommodate any extension above the head of the fastener when the (i) distal-end region of length D is slipped over the head of the fastener. The length E is greater than equal to zero but less than or equal to half the thickness H of the head of the fastener, 0≦E≦½H. Finally, either type shallow-well socket has (iii) a proximal-end region of length F internally suitable to engage of a rotary tool, the length F being greater than or equal to half the thickness H of the head of the fastener but less than or equal to the thickness H of the head of the fastener, ½H≦F≦H. In the case of a “driver socket” this length F is the length of the male drive post of the socket. In the case of a “double opening shallow-well socket” this length F combined with length E is the length of the male drive post engaging the socket.

In accordance with the present invention D+E+F=C, and C≦2.5H. In the vernacular, the socket (including its drive connection in the form or either an integral of a separate drive post) is no more than two and one-half times the height of the head of the largest fastener that it serves to drive.

In either of its versions, the shallow well socket is preferably retained to the rotary drive tool by a “snap lock” mechanism of substantially conventional construction. The shallow well socket is preferably retained to the rotary drive tool, or sprocket wrench, by one or more spring-loaded balls that engage a complimentary groove.

In the case of a “driver socket” which has an integral drive post, these spring-loaded balls are located on at least one, and preferably on two, sides of the square drive post, and extend as captured in cavities for a fraction of the diameter of the ball in order to engage, preferably, a groove of complimentary size that is within the square aperture of the sprocket wrench.

In the case of a “double opening shallow-well socket”, it will be recalled that this socket is used with a separate square drive post. In accordance with the present invention, each, and preferably both, ends of this square drive post has at least one, and preferably two, spring-loaded balls located on a corresponding one, or two, sides of the square drive post. These balls extend as captured in cavities for a fraction of the diameter of the ball in order to engage, preferably, one or more grooves of complimentary size that are within the square aperture of the sprocket wrench, and/or the square aperture of the socket.

2. Driving Shallow-Well Sockets with a Thin Sprocket/Socket Wrench

This shallow-well, and low-height, socket is suitably driven by a rotary tool. In the “driver socket” variant the integral drive post is, in its first region of height E combined with its second region of height F which second region extends into a female cavity of the rotary drive tool, of a total length E+F=P that greater than or equal to the thickness H of the head of the fastener but less than or equal to twice the thickness H of the head of the fastener, H≦P≦2H.

Furthermore, either variant of socket is preferably still further combined with a rotary tool that is very thin, and particularly a socket wrench. The thickness T of the rotary tool is preferably, in a region of the tool engaging the drive post, (i) greater than the thickness H of the head of the fastener but (ii) less than or equal to twice the thickness H of the head of the fastener, H≦P≦2H.

Thus this combination socket, rotary tool drive post, and rotary tool has—because some of the length P of the drive post fits within the length F proximal-end region of the socket while a remainder of the length P of the drive post fits within the thickness T of the rotary tool—a combined height—including all of the combination socket, rotary tool drive post, and rotary tool—equal to C+T≦3H. In the vernacular, the shallow-well socket and the rotary driver tool and the connection between them are, in total, no more than three times the height of the head of the fastener that is driven.

For example, the thickness of the head of a hexagon bolt of ⅜″ size is 0.243 inches. Therefore, and entire mechanism in accordance with the present invention to drive the head of this hexagon bolt is less than approximately 3/4 inch in total thickness. The shallow-well socket taken alone is less than 1/2 inch high.

Alternatively and by example, a set of sockets could be sized to its largest member suitable to engage (and turn) the thickness of the head of a hexagon nut of ⅜″ size, which thickness is 0.337 inches. Therefore, and entire mechanism in accordance with the present invention to drive the head of this hexagon nut would be less than approximately 1 inch in total thickness. The shallow-well socket alone would be less than 2/3 inch high.

3. Driving Shallow-Well Sockets with a New Sprocket/Socket Wrench with Mechanically-Linked Co-Rotating Turning Heads

The rotary tool used to drive the shallow-well sockets of the present invention is not only preferably itself thin, but is also preferably of a new type having (i) an elongate body, (ii) a rotatable turning head at each end of the elongate body, one of which turning heads couples rotation of the rotary tool drive post, and (iii) a mechanism within the body for mechanically linking rotation of each turning head to the other.

Each such turning head may in particular be a cylindrical body presenting at its exterior surface sprocket teeth. The one turning head coupling rotation of the rotary tool drive post then consists of a cylindrical body presenting at its interior a square aperture into which fits the drive post of square cross-section.

The mechanism of the rotary tool may in particular comprise a continuous loop chain engaging the exterior surface sprocket teeth of the cylindrical body of each turning head so as to link rotation of each turning head to the other.

Alternatively, the mechanism of the rotary tool may in particular comprise a line, or train, of gears intermeshing one to the next from the exterior surface gear teeth of one turning head to the exterior surface gear teeth of the other, the line of gears serving to mechanically link rotation of each turning head to the other.

Still further alternatively, the mechanism of the rotary tool may in particular comprise a shaft having affixed at each end a bevel gear, the bevel gear at each end intermeshing with the beveled gear teeth of the cylindrical body of one of the turning heads.

The simple reason that this new rotary drive tool is beneficially combined with the shallow-well sockets is synergism. The shallow-sell sockets do not require much clearance at the top of, and along the linear axis of, the turned fastener. And, as it will be recalled, these shallow-well sockets can also be made thin-wall. Meanwhile, the new rotary tool does not require any angular clearance at all. Combining all these properties makes that a rotary fastener may be engaged and turned in extremely tight quarters. The example of extracting a bolt deep within a pipe that is of but slightly greater diameter than the length of the bolt has already been given.

4. A Rotary Drive Tool System Suitable for Use in Tight Quarters

In another of its aspects the present invention is embodied in a rotary drive tool system suitable for use in tight quarters.

The system includes a shallow-well socket, a rotary tool, and a drive post to the tool.

The preferred shallow well socket is a generally tubular body of length C less than or equal to twice the thickness H of a head of a fastener that is turned by the body, C≦2H.

The socket connects to a rotary tool of width T less than or equal to the thickness H of a head of a fastener that is turned by the shallow-well socket body, T≦H through a drive post having a first region extending into a proximal-end region of the shallow well socket combined with a second region extending into the rotary drive tool. The two regions are of a total length P that greater than or equal to the thickness H of the head of the fastener but less than or equal to twice the thickness H of the head of the fastener, H≦P≦2H.

Thus, because enough of the length P of the drive post fits within the proximal-end region of the shallow-sell socket while remaining of the length P of the drive post fits within the thickness T of the rotary tool, the combined height of the combination socket, rotary tool drive post, and rotary tool is C+T≦3H.

These and other aspects and attributes of the present invention will become increasingly clear upon reference to the following drawings and accompanying specification.

### BRIEF DESCRIPTION OF THE DRAWINGS

Referring particularly to the drawings for the purpose of illustration only and not to limit the scope of the invention in any way, these illustrations follow:

FIG. 1 is a perspective view of a first embodiment of a sprocket/socket wrench in accordance with the related predecessor invention.

FIG. 2 is a cut-away plan view of the first embodiment of a sprocket/socket wrench in accordance with the related predecessor invention previously seen in FIG. 1 taken along aspect line 2-2, the cut-away view showing the chain drive of the wrench.

FIG. 3 is a perspective view of a second embodiment of a sprocket/socket wrench in accordance with the related predecessor invention.

FIG. 4 is a cut-away plan view of the second embodiment of a sprocket/socket wrench in accordance with the related predecessor invention previously seen in FIG. 3 taken along aspect line 3-3, the cut-away view showing the gear drive of the wrench.

FIG. 5 is a perspective view of a third embodiment of a sprocket/socket wrench in accordance with the related predecessor invention.

FIG. 6 is a cut-away plan view of the third embodiment of a sprocket/socket wrench in accordance with the related predecessor invention previously seen in FIG. 5 taken along aspect line 4-, the cut-away view showing the shaft drive of the wrench.

FIG. 7, consisting of FIGS. 7a and 7b, are side plan views of two variants of a shallow-well socket in accordance with the present invention, the second variant of FIG. 7b also being shown with a separate square drive post.

FIG. 8 is a detail view of a preferred “snap lock” mechanism for the integral drive post of, or for the detached drive post usable with, the shallow-well sockets of the present invention previously seen in FIG. 7.

FIG. 9a is a diagrammatic perspective views of a first, most preferred, embodiment of a rotary drive tool system in accordance with the present invention suitable for use in tight quarters, the embodiment of FIG. 9a using a “shallow-well driver socket” and a “shallow sprocket wrench”.

FIG. 9b is a diagrammatic perspective views of a second preferred embodiment of a rotary drive tool system in accordance with the present invention suitable for use in tight quarters, the embodiment of FIG. 9b using a “shallow-well socket”, a “square drive post” and a “shallow sprocket wrench”.

FIG. 9c is a diagrammatic perspective views of a third preferred embodiment of a rotary drive tool system in accordance with the present invention suitable for use in tight quarters, the embodiment of FIG. 9c using a “shallow-well socket” and a “shallow socket wrench”.

FIG. 10, consisting of FIGS. 10a and 10b, are plan views of a prior art hexagon bolt.

FIG. 11 is a prior art table of the ANSI standard measurements of the prior art hexagon bolt shown in FIG. 10.

FIG. 12, consisting of FIGS. 12a and 12b, are plan views of a prior art hexagon nut.

FIG. 13 is a prior art table of the ANSI standard measurements of the prior art hexagon nut shown in FIG. 12.

### DESCRIPTION OF THE PREFERRED EMBODIMENT

The following description is of the best mode contemplated for the carrying out of the invention. This description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

1. The Related Predecessor Invention, and Why it Uniquely Supports the Present Invention

The sprocket/socket wrench with mechanically-linked co-rotating turning heads of the related predecessor invention, and application, uniquely supports the shallow well sockets (mounting to short drive posts) the present invention because of at least tow reasons. First, these sprocket/socket wrenches can be, at least in one embodiment, made very thin. Second, by action of their mechanically-linked co-rotating turning heads, the sprocket/socket wrench can transpose torque, and rotation, from an accessible region where everything, and every motion, is at normal large scale to regions proximate the fastener where, nonetheless to being robust, any of the socket, the drive post and the associated region of the sprocket/socket wrench itself may be quite compact. In simplest terms, the predecessor invention, and application, taught how to transpose torque forces, and rotary motion, onto rotary fasteners located in tight quarters. The present invention, and application, teaches now the drive system at the location of the rotary fastener may, indeed, tolerate very tight quarters.

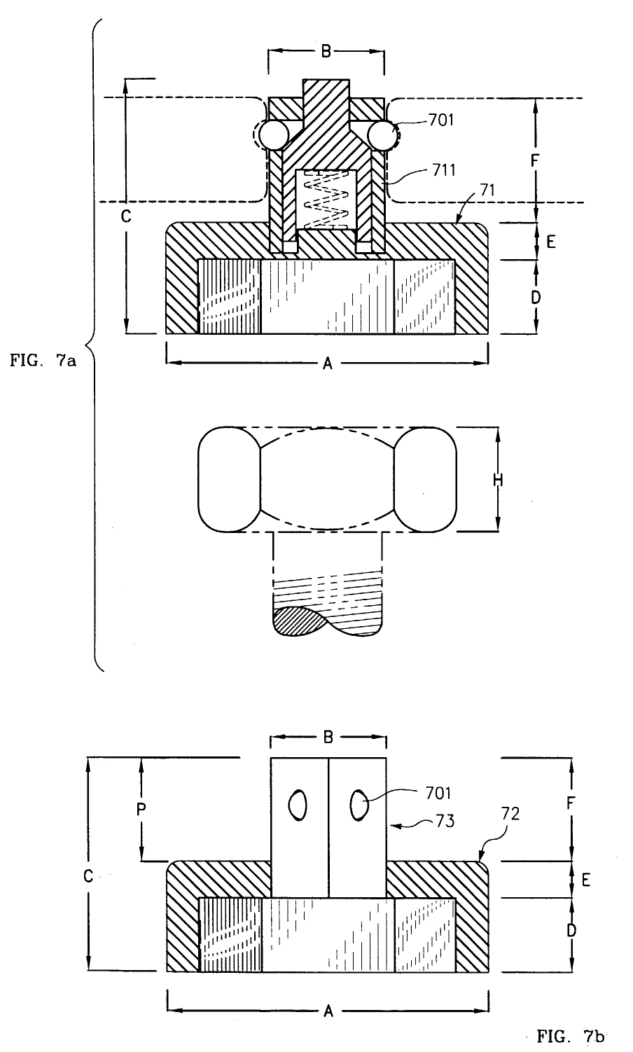

For the sake of completeness, the related predecessor invention, subject of the related predecessor application, is next again set forth in this application. Then, the principles of this device being understood, the shallow well sockets, and rotary driver system, or the present invention are taught commencing at FIG. 7, section 3 of this specification.

2.1 The Sprocket/Socket Wrench of the Predecessor Invention

The predecessor invention contemplates, and the predecessor application teaches, that a common ratchet wrench, such as is the subject of U.S. Pat. No. 2,500,835, expanded and adapted to include (1) a chain, (2) a series of gears, (3) a drive shaft, or still other drive mechanism between the two turning heads—each typically in the form of a sprocket or a spindle or a socket—located one at each end of the ratchet wrench. Although the rachet wrench can be operated conventionally, rotary motion and torque forces delivered into either turning head of the tool—such as may typically arise from coupling the one turning head to a separate and external socket wrench—are transmitted to, and replicated at, the other turning head of the tool. The tool thus translates rotational movements and torque forces about a proximal-end, driven, axis into like rotational movements and torque forces about a distal-end, driving, axis. In so doing it operates to displace strong rotary forces in a manner substantially dissimilar to all other tools known to the inventor.

2.2 Operation and Purpose of the Tool of the Related Predecessor Invention

The drive mechanism of the tool of the related predecessor invention functions to make that whenever rotation, and torque, is applied to a sprocket, square spindle, or socket at either end of the tool will cause a sprocket, square spindle, or socket at the other end of the tool to co-rotate in lock step.

Although the elongate body of the tool can undergo conventional pivoting and arcing motion from either end in order to turn in a ratcheting action a sprocket, square spindle or socket at the other end of the tool, in its most preferred operation an externally-derived rotational movement, and torquing force, are delivered into the tool. This rotational movement, and torquing force, may be so externally derived by, for example, a separate socket wrench.

This externally-derived rotational movement, and torquing force, is delivered into a sprocket or socket at one—either—end of the tool, and about a first axis, now defined as “driven” axis, that is substantially perpendicular to the axis of the tool. This external rotational movement and torquing force is commonly developed by a common hand-, electric-, or air-powered socket or torque wrench, and may be very strong.

This motion and this force as received into the turning head at one end of the tool is transmitted by a drive mechanism down the length of the tool and into the turning head at the other end of the tool. This second turning head—again in the form of a sprocket, a square spindle or a socket—engages a workpiece, now along a second axis, now defined as the “driving” axis, that is again substantially perpendicular to the tool. The rotational motion, and the torque torquing force, delivered about the “driving” axis serve to rotate and to torque the workpiece.

The first, “driven”, axis is thus spaced parallel to the second, “driving”, axis. The entire tool can thus be perceived as a force displacement mechanism. Namely, (1) potentially strong rotational and torque forces delivered into the tool at a first-location turning head and about a first, driven, axis into (2) equivalent rotational and torque forces delivered by the tool into a workpiece at a displaced, second, location and about a spaced-parallel second, driving, axis.

The purpose for mechanically linking the rotation of the turning heads at each end of the tool is simple. A distal-end turning head may be placed—including placement by use of an intermediary adapter such as a common socket—over the head of a bolt or like fastener that is located in extremely tight quarters, and at a location where normal direct access for turning the bolt or like fastener is effectively impossible. The body of the sprocket/socket tool in accordance with the related predecessor invention will then extend transversely from this distal-end turning head, positioning the proximal-end turning head into a region of greater accessibility. This proximal-end turning head is then suitably engaged by some external tool, such as a common hand or power socket wrench, so as to cause it to rotate. The induced rotation, and torque forces, thus imparted to the proximal-end turning head are transmitted by the mechanical mechanism down the body of the sprocket/socket tool and into the distal-end turning head, serving to rotate this distal-end turning head and the bolt or fastener.

A number of sprocket/socket tools in accordance with the related predecessor invention may even be combined in a “daisy chain” to deliver rotational motion and strong torquing forces around corners and the like. The sprocket/socket tool may be built in a “bent”, ar “arched”, version so that the body of the tool is not in a straight line between the torquing heads at each end of the tool. The sprocket/socket tool may and also, and independently, be built in an “offset” version so that rotational motions and torquing forces at each end of the tool are delivered each in a separate plane spaced-parallel to the other.

Each of the two turning heads of the tool can preferably serve at any one particular time as either that head which is imparting torquing force to an object outside the tool (the “driving” turning head), or that head which is receiving rotational motion and torquing force from outside the tool (the “driven” turning head).

Each of the two turning heads is extremely versatile in form. Each may especially from time to time, and at times, fit adapters that variously support both driving, and being driven. The most preferred turning heads are susceptible both to receive, and/or to produce, rotary motion and torquing forces from either side of the turning head and/or the sprocket/socket tool.

The tool may in any case be both (1) turned over (i.e., rotated 180° about its central axis) or (2) flipped end for end (i.e., rotated 180° in any plane about its center point).

A sprocket/socket wrench tool in accordance with the related predecessor invention may always be used, and may be used wheresoever located in any position along a daisy chain (insofar as external clearances locally so permit), in the manner of a normal and conventional pivoting and ratcheting ratchet, or socket, wrench. However, a great strength of the sprocket/socket wrench tool of the related predecessor invention that users soon come to experience the tool primarily as a means for communicating and transposing rotary motion and torquing forces in a manner quite separate and apart from the ratchet tools of the prior art (which the new tool of the related predecessor invention only superficially resembles). Users usually soon forgo any attempts at all to pivot the body of the tool of the related predecessor invention once it is positioned, and instead typically prefer simply to plug a conventional socket wrench or driver tool into the accessible second-end turning head, thereafter quickly and easily performing all manipulations from this offset location.

In particular, both light and strong torque forces may be imparted to and through the sprocket/socket tool of the related predecessor invention; the second end of the tool where the tool user applies rotational motions and forces giving through the force-transmitting mechanism of the tool substantially the same “feel” of the bolt or other fastener being torqued as if this bolt or fastener was being conventionally directly manipulated. The tool of the related predecessor invention is thus “transparent” in use, and the user need not struggle to learn and to calibrate motions and forces applied by use of the tool, but will feel these motions and forces in and as, most commonly, the completely normal and conventional motions and forces felt from use of the external socket wrench.

2.3 A Ratcheting Sprocket/Socket Wrench

Accordingly, in one of its aspects the related predecessor invention is embodied in an elongate body having a rotatable turning head at each end of the elongate body, with a mechanism within the body mechanically linking rotation of each turning head to the other.

Each turning head may be a partially hollow cylindrical body presenting at its exterior surface sprocket teeth. The hollow of the cylindrical body can be, by way of example, (1) a square aperture as will fit a square spindle, or (2) a “twelve-point”, “six-point”, or other aperture as fits over the head of a hexagonal bolt of nut. Each turning head may alternatively be a substantially solid cylindrical body still presenting at its exterior surface gear teeth. In this case one, or both, sides of the solid-cylinder turning head typically related predecessors a square spindle.

The mechanical mechanism within the body of the tool may be a continuous loop chain engaging the exterior surface sprocket teeth of the cylindrical body of each turning head so as to link rotation of each turning head to the other.

Either, or both, turning heads can optionally engage within the body of the tool a spring-loaded dog which permits rotation within but a single direction. The tool is then turned over to permit rotation in opposite directions. Because each turning head is rotationally linked to the other, it is clear that each spring-loaded dog must permit rotation in the same direction. The question might thus be raised: why bother with two? One answer is that a local anti-rotation dog can help absorb strong torque forces otherwise transmitted to the other end of the tool.

Likewise, either, or both, turning heads can optionally engage a sliding mechanism that locks all rotation. Again, since rotation of each turning head is linked to the other, the primary use of a sliding mechanism at both heads is to locally absorb such strong torque forces as must otherwise be transmitted to the other end of the tool.

The mechanical mechanism between the turning heads may alternatively be a line, or train, of gears intermeshing one to the next from the exterior surface gear teeth of one turning head to the exterior surface gear teeth of the other, this line of gears serving to mechanically link rotation of each turning head to the other.

The mechanical mechanism may still further alternatively be a shaft having affixed at each end a bevel gear; the bevel gear at each end of the shaft intermeshing with the beveled gear teeth of the cylindrical body of one of the turning heads.

Returning to the turning heads, these are substantially independent of the mechanical mechanism within the wrench by which rotational motion, and torque, is coupled between them. Regardless of the contours of its exterior circumference, the cylindrical body of each turning head may separately and independently assume diverse forms. For example, each and either cylindrical body may be in the form of a hollow cylinder with teeth suitable to engage a rotatable hexagonal fitting upon its interior circumferential surface. Per dictionary definition, such a body is called a “cylindrical sprocket”. It is manifestly suitable to engage at its interior circumference the hexagonal head of, by way of example, a bolt. A turning head so configured is thus suitable to rotate the bolt when the remaining turning head—to which it is mechanically linked by the chain, gear or shaft mechanism—is itself rotated.

Each and either cylindrical body may further alternatively be in the form of a solid cylinder, normally with a square spindle protruding to one or to both sides of the body. A tool so configured assumes the external form of a one, or two-, headed socket wrench. A turning head so configured is manifestly suitable to couple and to turn a common socket when it is itself rotated by the remaining turning head—to which it is mechanically linked by the chain, gear or shaft mechanism.

Each and either cylindrical body may still further alternatively be in the form of a hollow cylinder with a central opening suitable to engage a square spindle, ergo a cylindrical sprocket suitable to engage at its central opening the square spindle of, by way of example, an external socket wrench. A turning head so configured is manifestly suitable to be rotated by a socket wrench—thus rotating also the remaining turning head to which it is mechanically linked by the chain, gear or shaft mechanism.

A number of such rachet wrenches in accordance with the related predecessor invention may be mechanically linked at their rotating heads one rachet wrench to the next in the manner of a daisy chain. The wrenches within the daisy chain need not be identical, nor identically coupled one to the next. The multiple-wrench daisy chain not only permits displacement of rotational motion, and toque forces, over a greater distance, but permits these motions and forces to be communicated along, and across, very convolute three-dimensional paths.

2.4 A Tool for Transmitting Rotary Motion and Torque Forces Across a Distance

In another of its aspects the related predecessor invention is embodied in a tool for transmitting rotary motion and torque forces across a distance.

The tool includes (i) an elongate body with a central axis, (ii) an externally-driven first rotatable head at one end of the elongate body accepting rotary motion and torque forces external to the tool along a driven axis that is perpendicular to the central axis, (iii) an externally-driving second rotatable head at the other end of the elongate body producing rotary motion and torque forces external to the tool along a drive axis that is both perpendicular to the central axis and spaced parallel to the driven axis by a distance of separation of the first and the second rotatable heads, and (iv) a mechanism within the body mechanically linking rotation of the externally-driven first rotatable head to the externally-driving second rotatable head. By this construction, and this coaction, rotary motion and torque forces are delivered from the driven axis, perpendicular to the central axis at the first rotatable head, to the driving axis, perpendicular to the central axis at the second rotatable head and spaced parallel to the driven axis.

The first rotatable head and the second rotatable head may be

In this rotary drive tool system the rotary tool preferably includes (i) an elongate body with a central axis, (ii) an externally-driven first rotatable head at one end of the elongate body accepting rotary motion and torque forces external to the tool along a driven axis that is perpendicular to the central axis, and (iii) an externally-driving second rotatable head at the other end of the elongate body producing rotary motion and torque forces external to the tool in the drive post and along a drive axis that is both perpendicular to the central axis and spaced parallel to the driven axis by a distance of separation of the first and the second rotatable heads.

A mechanism within the body mechanically links rotation of the externally-driven first rotatable head to the externally-driving second rotatable head.

Thereby rotary motion and torque forces are delivered from the driven axis, perpendicular to the central axis at the first rotatable head, to the drive post and about the driving axis, perpendicular to the central axis at the second rotatable head and spaced parallel to the driven axis.

The mechanism may comprise, by way of example, any of (i) a chain drive between the first rotatable head and the second rotatable head, (ii) a gear drive between the first rotatable head and the second rotatable head, and (iii) a shaft drive between the first rotatable head and the second rotatable head.

2.5 Preferred Embodiments of Sprocket/Socket Tools in Accordance with the Related Predecessor Invention

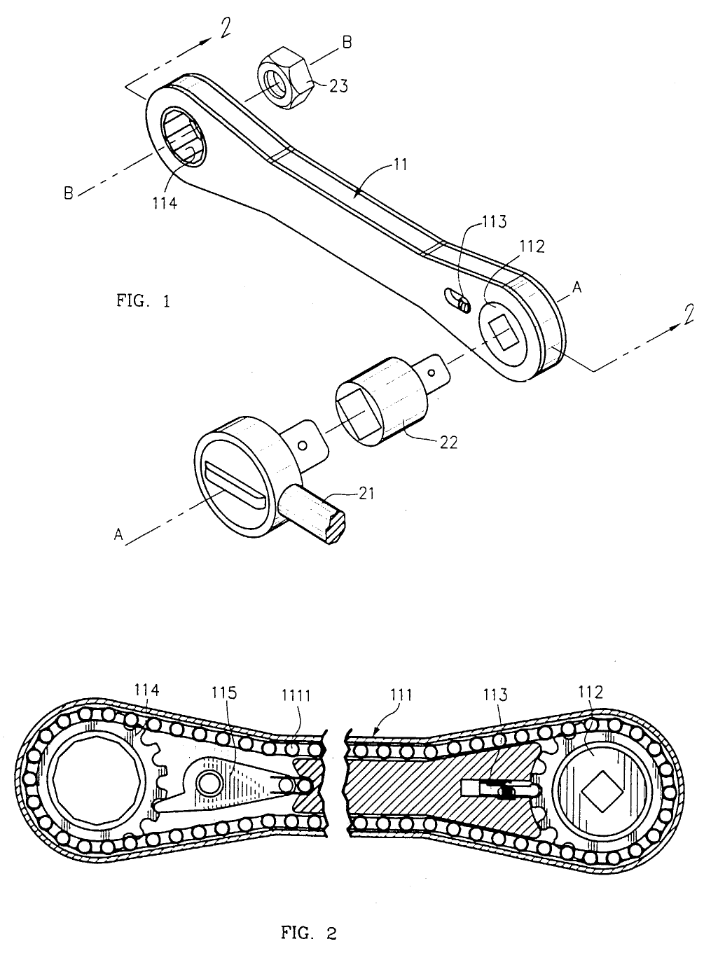

Three preferred embodiments of sprocket/socket tools 11, 12 and 13 in accordance with the related predecessor invention are respectively shown in perspective view in FIGS. 1, 3 and 5, and in x-ray plan view in FIGS. 2, 4 and 6. All tools 11, 12, 13 appear substantially identical to the exterior; visual differences between the tools being mostly dependent upon different configurations of sprocket and socket driving heads at each end of the tools 11, 12, 13. However, the various configurations of the driving heads can be fitted to any embodiment, the particular driving heads configurations shown in the drawings for each embodiment of the tools 11, 12 and 13 being exemplary only.

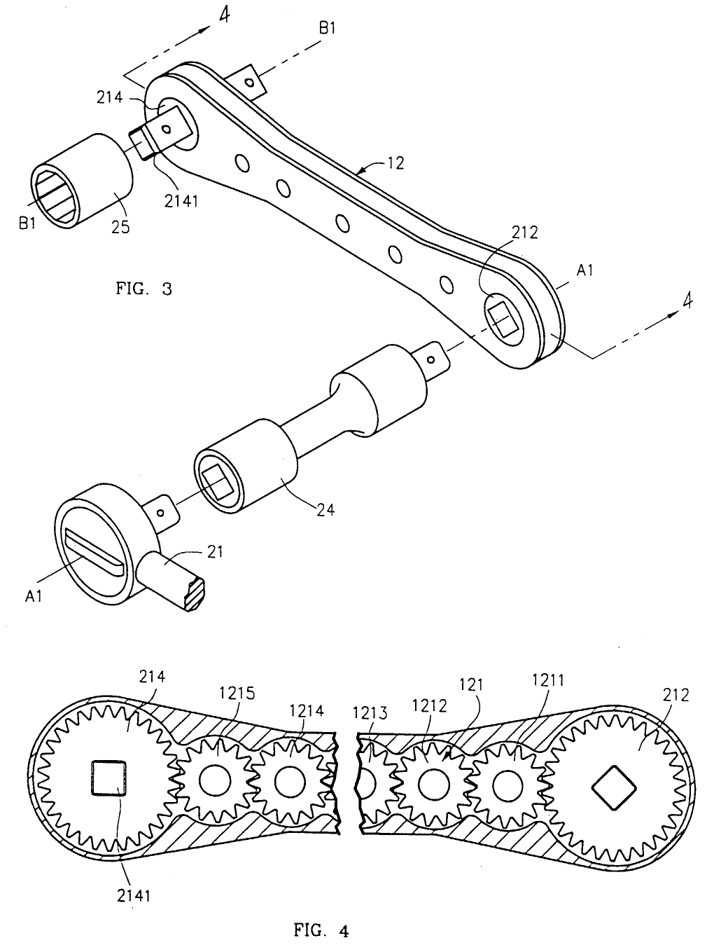

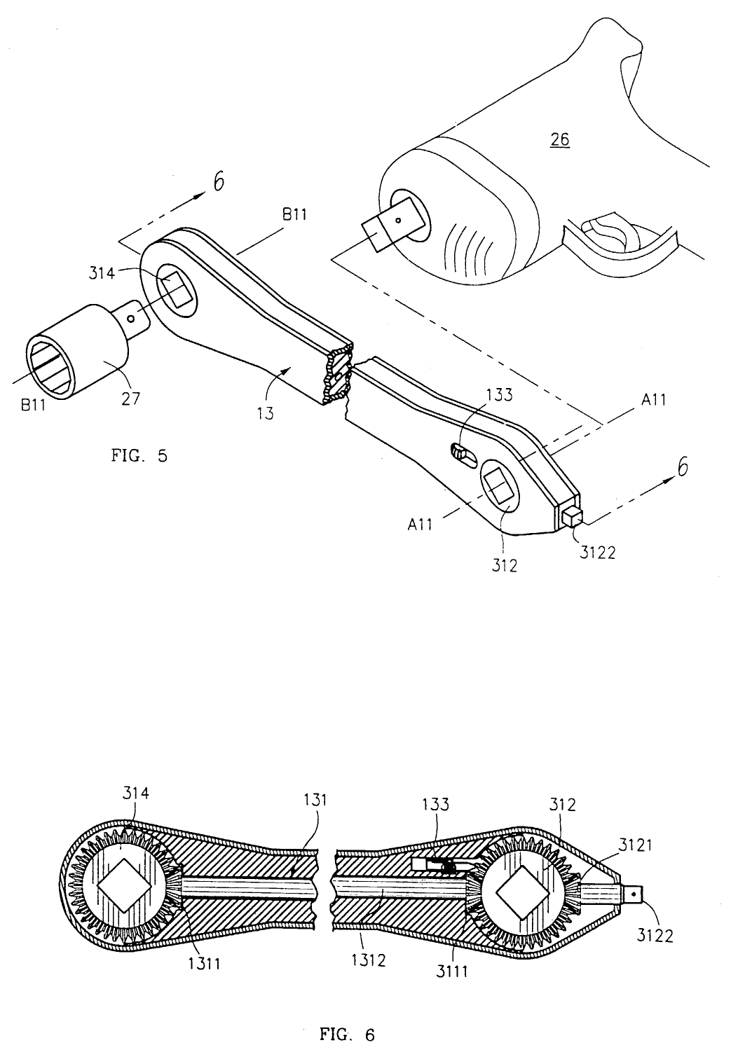

The first embodiment of the sprocket/socket tool 11 shown in FIGS. 1 and 2 is called the chain drive embodiment after its chain drive 111 prominently visible in the cut-away view of FIG. 2. The second embodiment of the sprocket/socket tool 12 shown in FIGS. 3 and 4 is called the gear drive embodiment after its gear drive 121 prominently visible in the cut-away view of FIG. 4. The third embodiment of the sprocket/socket tool 13 shown in FIGS. 5 and 6 is called the shaft drive embodiment after its shaft drive 131 prominently visible in the cut-away view of FIG. 6.

In each embodiment the chain drive 111, the gear drive 121 or the shaft drive 131 serves to translate rotary motion, and torquing forces, delivered into the tool 11, 12, 13 at an arbitrarily selected first-end driving head into corresponding rotary motion, and torque forces, at the tools second-end driving head.

For example, in the first embodiment of the tool 11 shown in FIGS. 1 and 2, rotary motion and torquing forces are delivered into the tool 11 at a first-end turning head that consists of square-aperture sprocket sleeve 112 from a socket wrench 21 acting through an adapter 22 (shown in exploded view, and also in phantom line for not being part of the related predecessor invention) Note that this rotary motion, and this torquing force, is delivered about an axis A-A that is substantially perpendicular to both the elongate axis 2-2 of the tool, and the plane of the sprocket sleeve 112. With the sprocket sleeve detente 112 in the withdrawn position—oppositely to the position shown in FIGS. 1 and 2—rotary motion of the sprocket sleeve 112 in either rotational directional sense is translated into rotary motion of the closed-loop chain 1111 of the chain drive 111, and causes lock-step rotation of the second-end turning head consisting of sprocket sleeve 114. This sprocket sleeve 114 has, by way of an example, an internal twelve-point aperture suitable to engage, for example, a nut 23 (shown in phantom line for not being part of the related predecessor invention). Note also that this rotary motion, and this torquing force, is delivered along an axis B-B that is again substantially perpendicular to both the elongate axis 2-2 of the tool, and to the plane of the sprocket sleeve 114. The drive axis B-B is, as illustrated, spaced parallel to the driven axis A-A.

In detail of construction for the tool 11, the chain 1111 is normally made of steel links complimentary in size and spacing to external sprocket teeth on the exterior circumferences of each of the sprocket sleeves 112, 114. The chain 1111 is constrained to run in a track formed by the body of the tool 1, which body is normally stamped in two or more pieces. If desired, the body can be made wider in its central regions so as to reduce any tendency of strong forces on the chain to bow outward the shell of the body. In accordance that the chain 1111 and sprocket sleeves 112, 114 are preferably hardened steel, with the body of the tool 11 closely confining all, the chain 1111 and/or the exterior teeth of the sprocket sleeves 112, 114 are hard to break, and even a small chain of thickness 1/4 inch (0.5 centimeter) may typically transmit hundreds of foot pounds (scores of kilogram meters) of torque. This is substantially independent of the length of the tool. The tool 11 can be broken, but is not normally subject to break in normal use, meaning use proportional to the reasonable torque forces applied to rotary fasteners subject to being engaged by the tool 11, or to forces reasonably applied to the tool 11 by external socket wrench 21 and the like of size corresponding to the tool 11.

Further in detail of construction for the tool 11, a sliding detente 113 permits locking the rotation of all parts: sprocket sleeves 112, 114 and chain 1111. A spring-loaded dog 115 engages the exterior teeth of the sprocket sleeve 114, permitting such rotation in only one direction as provides for a ratcheting action. (This ratcheting action is independent of, and in addition to, any ratcheting action that may be exhibited by an external rachet tool such as, inter alia, the socket wrench 21.) According to this unidirectional rotation, the tool 11 is turned over to effect ratcheting rotation in each—a clockwise and a counterclockwise—direction.

Note that the spring-loaded dog 115 permitting rotation within but a single direction could be duplicated at each end of the tool 11. Because each turning head sleeve 112, 114 is rotationally linked to the other by chain 1111, it is clear that two spring-loaded dogs must each permit rotation in the same direction. The reason to even bother with two is that a local anti-rotation dog can help absorb strong torque forces otherwise transmitted to the other end of the tool. Likewise, the sliding detente 113 that locks all rotation could be duplicated at both turning head sleeves 112 (where presently illustrated) and 114 so as to best locally absorb such strong torque forces as must otherwise be transmitted to the other end of the tool.

Similarly, in the second embodiment of the tool 12 shown in FIGS. 3 and 4, rotary motion and torquing forces are delivered into the tool 12 at a first-end turning head again consisting of square-aperture sprocket sleeve 212, and again from a socket wrench 21 acting through a long adapter 24 (shown in exploded view, and also in phantom line for not being part of the related predecessor invention). Note that this rotary motion, and this torquing force, is delivered about an axis A′-A′ that is substantially perpendicular to both the elongate axis 4-4 of the tool, and the plane of the sprocket sleeve 212. Rotary motion of the sprocket sleeve 212 in either rotational directional sense is translated into rotary motion of the gears 1211-1215 of the gear drive 121, and causes lock-step rotation of the second-end turning head consisting of sprocket spindle 214. This sprocket spindle 214 has, by way of an example, a square spindle 2141, illustrated extending in two directions along axis B′-B′ but optionally extending on only one direction—suitable to engage, for example, a socket 23 (shown in phantom line for not being part of the related predecessor invention). Note yet again that this rotary motion, and this torquing force, is delivered along an axis B′-B″ that is again substantially perpendicular to both the elongate axis 2-2 of the tool, and to the plane of the sprocket spindle 214. The drive axis B′-B′ is, as illustrated, spaced parallel to the driven axis A′-A′.

In detail of construction for the tool 12, the intermeshing gears 1211-1215—which may vary in size and number—are normally made of hardened steel, as are the sprocket sleeve 212 and the sprocket spindle 214, each of which mounts complimentary gear teeth on it external circumference. The intermeshing gears 1211-1215 may vary in size and number, and whether the number of gears is odd or even will influence whether the clockwise or counterclockwise rotational sense at the driven sprocket sleeve 21 is the same, or reversed, from the clockwise or counterclockwise rotational sense at the driving sprocket spindle 214.

As was the chain drive 111 in the tool 11 of FIGS. 1 and 2, the gear drive 121 of the tool 12 of FIGS. 3 and 4 is retained tightly within the housing of the tool 12. The center posts of the gears 1211-1215 are preferably steel rivets also used to join a preferred two halves of the housing. All in all, the gears 1211-1215, the sprocket sleeve 212, and the sprocket spindle 214 are all strongly maintained in position, and are hard to break or dislodge. The second embodiment of the tool 12, which can be constructed relatively inexpensively using in some cases stock gears, is perhaps the strongest of the three embodiments.

A third exemplary embodiment of the tool 13 in accordance with the related predecessor invention is shown in FIGS. 5 and 6. This embodiment, which employs a shaft drive 131, is often built at relatively longer lengths than the first embodiment tool 11 of FIGS. 1 and 2, and the second embodiment tool 12 of FIGS. 3 and 4, because the shaft drive, although potentially neither as strong nor as permanently aligned as is the chain drive 111 or the gear drive 121 (respectively shown in FIGS. 2 and 4), is relatively lightweight.

In a manner that should by now be familiar, rotary motion and torquing forces are delivered into the tool 13 at a first-end turning head yet again consisting of square-aperture sprocket sleeve 213. This time the forces are delivered from a power driver tool 26 (shown in phantom line for not being part of the invention), and from an opposite side of the tool 13 to the driven element of pluggable socket 27 (also shown in phantom line for not being part of the invention). Note that the sprocket sleeves 312, 314 at each end of the tool 13 have the same internal form—a square aperture. Usually one only is, however, checked in rotation by a spring-loaded dog 133 (seen in FIG. 6) so as to permissively undergo ratcheting rotation in one only directional sense.

Note in FIG. 4 that the exterior circumference of the sprocket sleeves 312, 314 preferably related predecessors a complex contour. The external circumference is notched, as in a gear, while a bevel gear surface, normally oriented at 45°, is also presented to, and intermeshed with, a conical-contour bevel gear head 1311 at each end of the shaft 1312.

The third embodiment of the related predecessor invention in tool 13 related predecessors an opportunity to import along yet another axis—this time coaxial with the axis of the tool along aspect line 6-6, such rotational movement, and torque forces, into the tool 13 as do cause rotational movement, and torquing forces, of its sprocket sleeves 312, 314. This may be realized by auxiliary drive head 3122, which most commonly couples a socket drive. Rotational motion and toque forces provided at this auxiliary drive head 3122 are transmitted down a stub shaft and into a bevel gear to drive the same sprocket sleeve 312 that is otherwise driven in rotation by the power diver tool 26, or equivalent, about the axis A11-A11. As illustrated, this smaller auxiliary drive head 3122 may be, by way of example, a ¼″ drive while the main drive is ⅜″ or even ½′, making that this auxiliary drive head is most commonly used for speeding rotation of the sprocket sleeves 312, 314 under light torque forces, with high-torque forces being otherwise realized.

The bevel, spur and ring gear components, and force transmission through these components, is challenging unless careful attention in paid to establishing and maintaining alignments and, insofar as is possible, broad, strong and substantial areas of contact. In this area a practitioner of the mechanical arts must use his or her intelligence and experience as to how to do things commensurate with the magnitude of the torque forces that are desired to be transmitted.

In the first place, the shaft 1312 can be held firmly within a corresponding central bore of the body of the tool 13, which body can be, it can be imagined, thinner than illustrated in FIGS. 5 and 6. Next, the conical gear head 1311 can be much larger—but this serves to thicken at least the driving head regions of the tool 13. Next, each bevel gear head 1312 can be built in two identical tapered halves which, when reversed one upon another and fastened strongly together, provide that the corresponding bevel gear head 1311 of the shaft drive 131 is captured between them.

In this manner, and others within the ability of a practitioner of the mechanical arts, the shaft drive 131 can be made alternatively, and stronger, than it appears in FIGS. 5 and 6 if so desired. Nonetheless to this possibility, and nonetheless that the construction of the shaft drive is again economical, the shaft drive is not preferred overall for tools that are placed in service with amateur mechanics because, when constructed at normal sizes from conventional steels, the shaft drive tool 13 can usually be stressed to failure at extreme high torque loads. The most common failure mode is a stripping of the bevel gears 312, 1311, but if these are very strong (at commensurate cost) and the shaft very long, then it is possible to torsion the shaft 1312.

A number of rachet wrenches in accordance with the related predecessor invention may be mechanically linked at their rotating heads one rachet wrench to the next in the manner of a daisy chain. It is trivial to envision a straight extension of plural wrenches, and only slightly harder to envision that each wrench may be canted at virtual any angle −170° to +170° to the previous wrench in line. It is accordingly well within the ability of a craftsman or mechanic to figure out how to “gang” wrenches—possibly with adapters even two different wrenches of a same “set”—so as to transmit rotational motion, and torque forces, around a corner.

Choice of linkage components becomes a bit more “tricky” when three dimensions are involved. However, problems in imparting rotary motion at points, and along axis, displaced in three dimensions are also soluble by use of multiple “daisy-chained” tools of the related predecessor invention (with necessary socket drive extension pieces). Construction of these sometimes arcane combinations is left to the imagination of the reader; a good practice problem being to figure out in theory how to remove the lug nuts from the wheel of a 4-wheel vehicle from a position outside the diagonally opposite wheel.

In accordance with the preceding explanation, variations and adaptations of the ratchet and socket wrenches in accordance with the related predecessor invention will suggest themselves to a practitioner of the mechanical and/or tool arts. For example, a great number of driving heads of diverse individual, and joint, configuration are clearly possible. This is why the tool of the related predecessor invention is suitably spoken of as a sprocket wrench, or as a socket wrench: merely adapting spindles and sockets—instead of sprockets—to the driving heads can may the tool of the related predecessor invention into something that is arguably as close to a double ended socket wrench, or, alternatively, a socket wrench with a drive input at the end of its handle, as a modified sprocket wrench.

For example, the tools 12, 13 of the related predecessor invention can be built with an offset at one or both ends by making the gear drive (of the tool 12) or the shaft drive (of the tool 13) to be multi-segment.

Finally, and by momentary reference to FIG. 6, it takes but little imagination to contemplate that the first-end sprocket sleeve 312 should be discarded, and that the driven end of the shaft 1312 should end butt-on in square spindle, or the like, that might be engaged by a socket wrench or the like so as to be rotated. For that matter, the first-end sprocket sleeve 312 may be maintained in place, and a new bevel gear 3121 connected to a stub drive shaft 3122 located at the proximal end of the tool 13.

3. Particular Preferred Shallow-Well Sockets in Accordance with the Present Invention

A side plan view of a first embodiment of shallow-well socket 71 in accordance with the present invention is shown in FIG. 7a. A side plan view of a second embodiment of a shallow-well socket 72, along with a separate square drive post 73, is shown in FIG. 7b. Shallow well socket 71 is called a “shallow well driver socket”, and has an integral drive post region 711 by which, and through which, drive is effected. The socket 72 is called simply a “shallow well socket”, and has, as is conventional with sockets, an opening to receive a turning part of rotary fastener and an opposed opening to receive a drive post.

The end diameter of the shallow-well sockets 71, 72 is dimension A; the drive end diameter of each socket 71, 72 is dimension B. The total height of the “shallow-well driver socket 71” is dimension C, and, in the case of the “shallow-well socket 72”, the dimension C is the height of both the socket 72 proper and the square drive post 73. The depth of the sockets 71, 72 is dimension D. There is effectively no bolt clearance (at the base of the socket cavity) in excess of this depth in the illustrated sockets 71, 72, but some slight bolt clearance can sometimes be relieved in the structure of driver socket 71. Essentially the sockets are very short, and shallow, and of a depth not heretofore deemed especially useful. The thickness of the back wall of the socket cavity along the axis of the sockets 71, 72 is E. The length of the integral drive post 711 in the driver shallow well socket 71, and that portion of separate drive post 73 that extends beyond the socket 72, is dimension F.

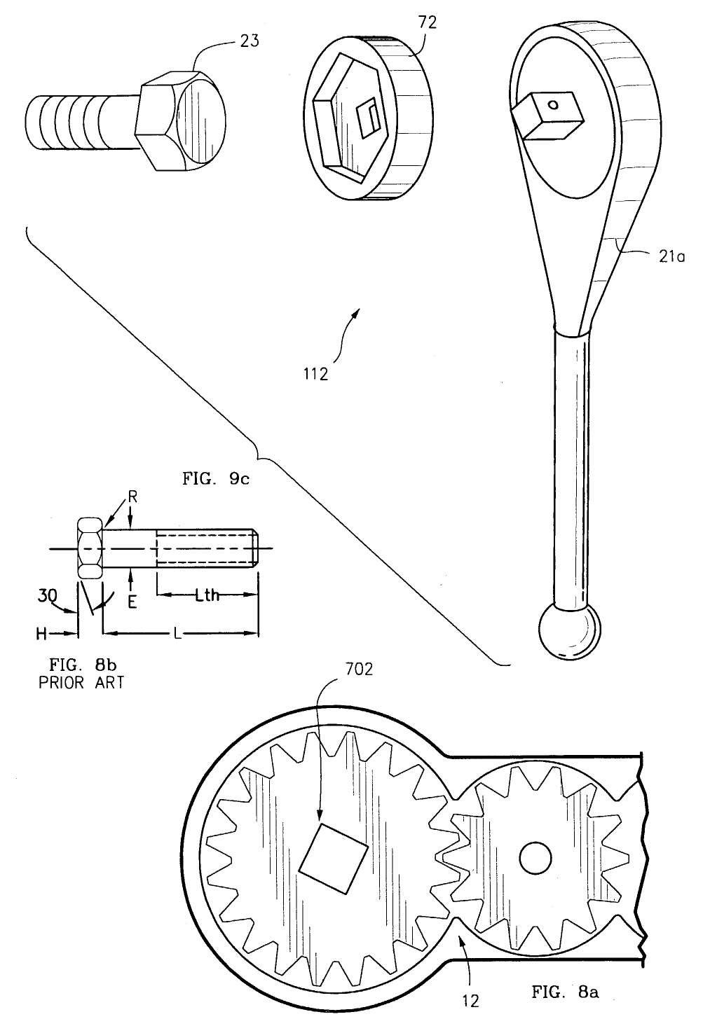

In accordance with the present invention, the distal-end region of length D—internally suitable to fit the head of the fastener—of either socket 71, 72 is greater than or equal to half the thickness H of the head of the fastener (see FIG. 8) but less than or equal to the thickness H of the head of the fastener, ½H≦D≦H.

Either type shallow-well socket 71, 72 further has a (ii) a central region of length E which forms the base of the socket, plus any void suitable to accommodate any extension above the head of the fastener when the distal-end region of length D is slipped over the head of the fastener. In the drawings of FIG. 7, this void greater than equal to zero but less than or equal to half the thickness H of the head of the fastener, 0≦E≦½H.

Finally in the drawings of FIG. 7, either type shallow-well socket 71, 72 has (iii) a proximal-end region of length F internally suitable to engage of a rotary tool, the length F being greater than or equal to half the thickness H of the head of the fastener but less than or equal to the thickness H of the head of the fastener, ½H≦F≦H. In the case of the “driver socket 71” this length F is the length of the male drive post 711 of the socket 71. In the case of a double opening shallow-well socket 72 this length F combined with length E is the length of the male drive post 73 engaging the socket 72.

In accordance with the present invention D+E+F=C, and C≦2H. In the vernacular, either socket 7, 72 (including its drive connection in the form or either an integral drive extension 711 or a separate drive post 72) is no more than twice the height of the head H of the fastener (H≦D) that the socket 71, 72 serves to drive.

In either of its embodiments the shallow well socket 71, 72 is preferably retained to the rotary drive tool by a “snap lock” mechanism 701 of substantially conventional construction. The shallow well sockets 71, 72 are preferably retained to the rotary drive tool, or sprocket wrench, by one or more spring-loaded balls that engage a complimentary groove 702 in the sprocket wrench 12, as shown in FIG. 9.

In the case of a “driver socket 71” which has an integral drive post 711, these spring-loaded balls 701 are located on at least one, and preferably on two, sides of the integral square drive post 711, and extend as captured in cavities for a fraction of the diameter of the ball in order to engage, preferably, a groove of complimentary size 702 that is within the square aperture of the sprocket wrench 12 (see FIG. 9).

In the case of a double opening shallow-well socket 72, it will be recalled that this socket 72 is used with a separate square drive post 73. In accordance with the present invention, each, and preferably both, ends of this square drive post 73 has at least one, and preferably two, spring-loaded balls located on a corresponding one, or two, sides of the square drive post 73. These balls extend as captured in cavities for a fraction of the diameter of the ball in order to engage, preferably, one or more grooves of complimentary size that are within the square aperture of the sprocket wrench, and/or the square aperture of the socket.

4. Particular Preferred Driver Systems Consisting of Shallow-Well Sockets and Preferred Driver Tools Both in Accordance with the Present and Related Invention

A first, most preferred, embodiment of a rotary drive tool system 100 in accordance with the present invention suitable for use in tight quarters is shown in diagrammatic perspective view in FIG. 10a. The embodiment of FIG. 10a uses a “shallow-well driver socket 71 and a “shallow sprocket wrench 12a” to drive, by way of example, a hexagonal head bolt 231.

A second preferred embodiment of a rotary drive tool system 101 in accordance with the present invention suitable for use in tight quarters is likewise shown in diagrammatic perspective view in FIG. 10b. The system 101 uses a “shallow-well socket 72”, a “square drive post 73” and a “shallow sprocket wrench 12a” to drive the hexagonal head bolt 231.

Finally, a third preferred embodiment of a rotary drive tool system 102 in accordance with the present invention suitable for use in tight quarters is still further likewise shown in FIG. 10c. The system 102 uses a “shallow-well socket 72” and a “shallow socket wrench 21a”.

The shallow-well, and low-height, sockets 71 are thus suitably driven by any of rotary sprocket tools 12a, or a socket tool 23a. In the “driver socket 71” the integral drive post 711 is, in its first region of height E combined with its second region of height F which second region extends into a female cavity of the rotary drive tool, of a total length E+F=P that greater than or equal to the thickness H of the head of the fastener but less than or equal to twice the thickness H of the head of the fastener, H≦P≦2H.

Furthermore, either variant of 71, 72 socket is preferably still further combined with a rotary tool 12a, 23a that is very thin, and particularly a sprocket wrench 12a. The thickness T of the rotary tools 12a, 23a is preferably, in a region of the tool engaging the drive post 711 or 73, (i) greater than or equal to half the thickness H of the head of the fastener but (ii) less than or equal to the thickness H of the head of the fastener, ½H≦P≦H.

Thus this combination socket, rotary tool drive post, and rotary tool has—because some of the length P of the drive post fits within the length F proximal-end region of the socket while a remainder of the length P of the drive post fits within the thickness T of the rotary tool—a combined height—including all of the combination socket, rotary tool drive post, and rotary tool—equal to C+T≦3H. In the vernacular, the shallow-well socket and the rotary driver tool and the connection between them are, in total, no more than three times the height of the head of the fastener that is driven.

For example, the thickness of the head of a hexagon bolt of ⅜″ size is 0.243 inches. Therefore, and entire mechanism in accordance with the present invention to drive the head of this hexagon bolt is less than approximately 3/4 inch in total thickness. The shallow-well socket alone is less than 1/2 inch high.

For example, the thickness of the head of a hexagon nut of ⅜″ size is 0.337 inches. Therefore, and entire mechanism in accordance with the present invention to drive the head of this hexagon bolt is less than approximately 1 inch in total thickness. The shallow-well socket alone is less than 2/3 inch high.

The rotary sprocket tool used to drive the shallow-well sockets of the present invention is not only preferably itself thin, but is also preferably of a new type of the related predecessor invention having (i) an elongate body, (ii) a rotatable turning head at each end of the elongate body, one of which turning heads couples rotation of the rotary tool drive post, and (iii) a mechanism within the body for mechanically linking rotation of each turning head to the other. It is more preferably the second embodiment of this tool, as is shown in FIGS. 3 and 4.

Each such turning head may in particular be a cylindrical body presenting at its exterior surface sprocket teeth. The one turning head coupling rotation of the rotary tool drive post then consists of a cylindrical body presenting at its interior a square aperture into which fits the drive post of square cross-section.

The mechanism of the rotary tool may in particular comprise a continuous loop chain engaging the exterior surface sprocket teeth of the cylindrical body of each turning head so as to link rotation of each turning head to the other.

Alternatively, the mechanism of the rotary tool may in particular comprise a line, or train, of gears intermeshing one to the next from the exterior surface gear teeth of one turning head to the exterior surface gear teeth of the other, the line of gears serving to mechanically link rotation of each turning head to the other.

Still further alternatively, the mechanism of the rotary tool may in particular comprise a shaft having affixed at each end a bevel gear, the bevel gear at each end intermeshing with the beveled gear teeth of the cylindrical body of one of the turning heads.

The simple reason that this new rotary drive tool is beneficially combined with the shallow-well sockets is synergism. The shallow-sell sockets do not require much clearance at the top of, and along the linear axis of, the turned fastener. And, as it will be recalled, these shallow-well sockets can also be made thin-wall. Meanwhile, the new rotary tool does not require any angular clearance at all. Combining all these properties makes that a rotary fastener may be engaged and turned in extremely tight quarters. The example of extracting a bolt deep within a pipe that is of but slightly greater diameter than the length of the bolt has already been given.

The overall preferred rotary drive tool system 100, 1010, 102 are suitable for use in very tight quarters.

The preferred shallow well sockets 71, 72 are generally tubular bodies of length C less than or equal to twice the thickness H of a head of a fastener that is turned by the body, C≦2H.

Each socket 71, 72 connects to a rotary tool 12a, 23a of width T less than or equal to the thickness H of a head of a fastener that is turned by the shallow-well socket body, T≦H through a drive post having a first region extending into a proximal-end region of the shallow well socket combined with a second region extending into the rotary drive tool. The two regions are of a total length P that greater than or equal to the thickness H of the head of the fastener but less than or equal to twice the thickness H of the head of the fastener, H≦P≦2H.

Thus, because enough of the length P of the drive post fits within the proximal-end region of the shallow-well socket 71, 72 while remaining of the length P of the drive post 711, 73 fits within the thickness T of the rotary sprocket tool 12a, the combined height of the combination socket, rotary tool drive post, and rotary tool is C+T≦3H.

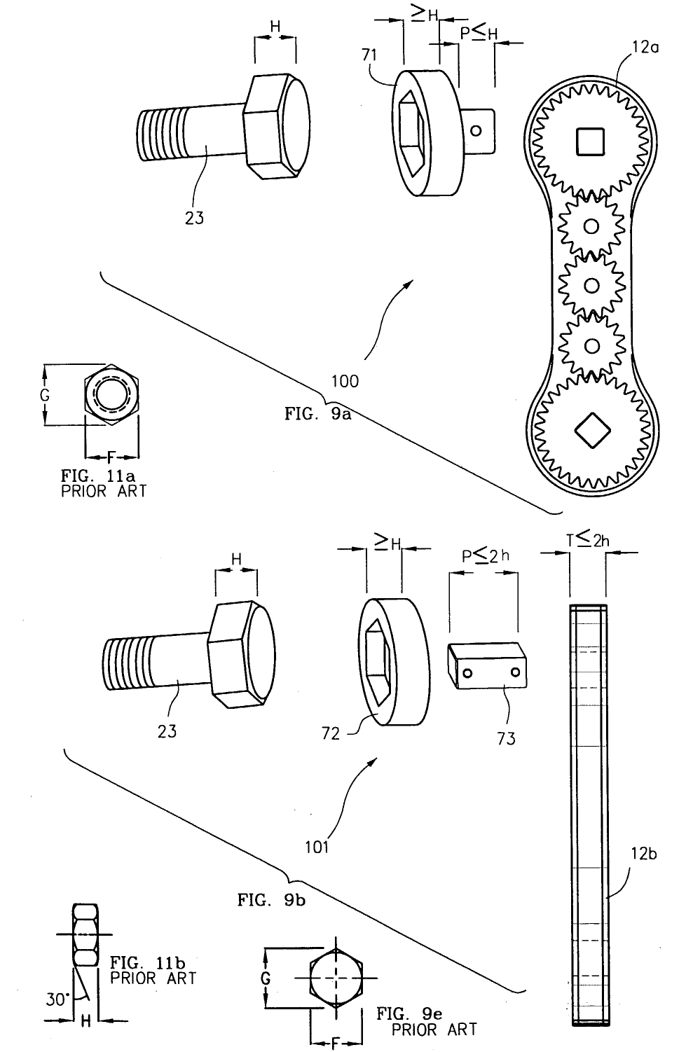

Plan views of a prior art hexagon bolt upon which the systems 100-103 of FIGS. 10a-10c are operative are shown in FIG. 11, consisting of FIGS. 11a and 11b, are plan views of a prior art hexagon bolt. A prior art table of the ANSI standard measurements of the prior art hexagon bolt is shown in FIG. 12.

Plan views of a prior art hexagon nut upon which the systems 100-103 of FIGS. 10a-10c are operative are shown in FIG. 13, consisting of FIGS. 13a and 13b, are plan views of a prior art hexagon bolt. A prior art table of the ANSI standard measurements of the prior art hexagon nut is shown in FIG. 14.

The prior art to the related predecessor invention shows that infinite variations like these are, if not trivial, well within the scope of the related predecessor intention. Therefore, in accordance with these and other possible variations and adaptations of the related predecessor invention, the scope of the invention should be determined in accordance with the following claims, only, and not solely in accordance with that embodiment within which the invention has been taught.

What is claimed is:

1. A shallow-well socket suitably driven by a rotary driver tool to apply torquing force to, and to turn, a fastener having a head of thickness H, the shallow-well socket comprising:
a generally tubular body of length C less than or equal to two and one-half times the thickness H of a head of a fastener that is turned by the body, C≦2.5H, the tubular body having in sequence from a first-end opening at length 0 which fits over the head of the fastener to a second-end opening at length C into which fits a drive post of a rotary tool, each of a
a substantially tubular distal-end region of length D internally suitable to fit the head of the fastener, the length D being greater than or equal to half the thickness H of the head of the fastener but less than or equal to the thickness H of the head of the fastener, ½H≦D≦H, connecting to
a substantially solid cylindrical central region of length E, greater than equal to zero but less than or equal to half the thickness H of the head of the fastener, 0≦E≦½H, connecting the distal-end region
a post-like proximal-end region of length F suitable to fit within a drive aperture of a rotary driver tool, the length F being greater than or equal to half the thickness H of the head of the fastener but less than or equal to the thickness H of the head of the fastener, ½H≦F≦H,
wherein D+E+F=C.

2. The socket according to claim 1
wherein the proximal-end region of length F internally suitable to fit within the drive aperture of the rotary driver tool has and presents a spring-loaded protrusion compressively mating with the groove so as to better temporarily hold the tubular body of the socket to the drive post of the rotary tool.

3. A shallow-well socket suitably driven by the drive post rotatably connected to a rotary driver tool to apply torquing force to, and to turn, a fastener having a head of thickness H, the shallow-well socket comprising:
a generally tubular body of length (D+E) less than or equal to one and one-half times the thickness H of a head of a fastener that is turned by the body, (D+E)≦1.5H, the tubular body having in sequence from a first-end opening at length 0 which fits over the head of the fastener to a second-end opening at length C into which fits a drive post of a rotary tool, each of a
a substantially tubular distal-end region of length D internally suitable to fit the head of the fastener, the length D being greater than or equal to half the thickness H of the head of the fastener but less than or equal to the thickness H of the head of the fastener, ½H≦D≦H, connecting to
a substantially-solid, centrally-apertured, cylindrical region of length E, greater than equal to zero but less than or equal to half the thickness H of the head of the fastener, 0≦E≦½H, the central aperture of the cylindrical region suitable to engage post of length F that is itself suitably rotated by a rotary driver tool, the length F of this external driver post being greater than or equal to half the thickness H of the head of the fastener but less than or equal to the thickness H of the head of the fastener, ½H≦F≦H, so as to be complimentary to the cylindrical region, D+E+F=C.

4. The socket according to claim 3 in combination with the drive post of the rotary tool wherein this drive post is, in a first region extending into the proximal-end region of the socket combined with a second region extending into the rotary drive tool, of a total length P that greater than or equal to the thickness H of the head of the fastener but less than or equal to twice the thickness H of the head of the fastener, H≦P≦2H.

5. The socket combined with a rotary tool drive post according to claim 3 in further combination with the rotary tool wherein the thickness T of the rotary tool is, in a region of the tool mounting the drive post, greater than or equal to the thickness H of the head of the fastener but less than or equal to twice the thickness H of the head of the fastener, H≦P≦2H.

5. The combination socket, rotary tool drive post, and rotary tool according to claim 4 wherein, because some of the length P of the drive post fits within the length F proximal-end region of the socket while some of the length P of the drive post fits within the thickness T of the rotary tool, the combined height of the combination socket, rotary tool drive post, and rotary tool is C+T≦3H.

6. The socket combined with a rotary tool drive post according to claim 3 in further combination with the rotary tool comprising:
a elongate body:
a rotatable turning head at each end of the elongate body, one of which turning heads couples rotation of the rotary tool drive post; and
a mechanism within the body for mechanically linking rotation of each turning head to the other.

7. The combination socket, rotary tool drive post, and rotary tool according to claim 6 wherein each turning head comprises:
a cylindrical body presenting at its exterior surface sprocket teeth;
and wherein the one turning head coupling rotation of the rotary tool drive post comprises:
a cylindrical body presenting at its interior a square aperture into which fits the drive post of square cross-section.

8. The combination socket, rotary tool drive post, and rotary tool according to claim 7 wherein the mechanism of the rotary tool comprises:
a continuous loop chain engaging the exterior surface sprocket teeth of the cylindrical body of each turning head so as to link rotation of each turning head to the other.

9. The combination socket, rotary tool drive post, and rotary tool according to claim 7 wherein the mechanism of the rotary tool comprises:
a line, or train, of gears intermeshing one to the next from the exterior surface gear teeth of one turning head to the exterior surface gear teeth of the other, the line of gears serving to mechanically link rotation of each turning head to the other.

10. The combination socket, rotary tool drive post, and rotary tool according to claim 7 wherein the mechanism of the rotary tool comprises:
a shaft; having affixed at each end
a bevel gear, the bevel gear at each end intermeshing with the beveled gear teeth of the cylindrical body of one of the turning heads.

11. A shallow-well socket suitably driven by the aperture of a rotary sprocket tool to apply torquing force to, and to turn, a fastener having a head of thickness H, the shallow-well socket being in combination with a drive post, the combination shallow-well socket and drive post comprising:
a generally tubular body of length (D+E) less than or equal to one and one-half times the thickness H of a head of a fastener that is turned by the body, (D+E)≦1.5H, the tubular body having in sequence from a first-end opening at length 0 which fits over the head of the fastener to a second-end post at length C which fits into a drive aperture of a rotary sprocket tool, each of a
a distal-end region of length D internally suitable to fit the head of the fastener, the length D being greater than or equal to half the thickness H of the head of the fastener but less than or equal to the thickness H of the head of the fastener, ½H≦D≦H, connecting to
a central region of length E suitable to accommodate a back wall to a distal-end region cavity, the length E being greater than zero but less than or equal to one-half the thickness H, of the head of the fastener, 0≦E≦½H; connecting to
a proximal-end post region of length P internally suitable to fit into the drive aperture of a rotary sprocket tool, the length P being greater than or equal to the thickness H of the head of the fastener but less than or equal to twice the thickness H of the head of the fastener, H≦F≦2H;
wherein the total height of the shallow-well socket and drive post is, in combination, (D+E)+P≦1.5H+2H≦3.5H.

12. The combination shallow-well socket and drive post according to claim 11 wherein the drive post is integral with the socket, and is attachable and detachable to the rotary drive sprocket.

13. The combination shallow-well socket and drive post according to claim 11 wherein the drive post is attachable and detachable to both the rotary drive sprocket.
